(19) United States
(12) Patent Application Publication
(10) Pub. No.: US 2009/0272753 A1
(43) Pub. Date: Nov. 5, 2009

(54) Self Forming Beverage Container Sleeve

(75) Inventors: Gary Andrew Rebelak, SR., Rockford, IL (US); Robson Terry Young, JR., Kirkland, IL (US)

Correspondence Address: REINHART BOERNER VAN DEUREN P.C., 2215 PERRYGREEN WAY, ROCKFORD, IL, 61107, US

(73) Assignee: Paperkoozy LLC, Roscoe, IL (US)

(21) Appl. No.: 12/112,077

(22) Filed: Apr. 30, 2008

(51) Int. Cl. B65D 25/00; B65D 83/72; G09F 3/00

(52) U.S. Cl. 220/737; 220/592.17; 40/306

(57) ABSTRACT

A sleeve is provided for a beverage container, configured to be self formed on the beverage container and adapted to fit beverage containers having various diameters.

### FIELD OF THE INVENTION

This invention generally relates to beverage container holders, and more particularly to beverage container sleeves having promotional items.

### BACKGROUND OF THE INVENTION

Beverage container sleeves for various beverage containers have been known in the art. The beverage container sleeves can have insulation functions to protect users' hands from hot or cold beverage temperatures and provide a better grip of the beverage container. For example, coffee cup sleeves formed of a corrugated paper material or beverage can sleeves formed of a polymeric foam material are readily available in the market. The beverage container sleeves are also used as marketing items. Such beverage container sleeves are printed with logos and other promotional images or messages.

Most of these beverage container sleeves are preformed to fit one size beverage containers. Unfortunately, beverage containers come in different diameters. However, production of various size beverage container sleeves to fit different size beverage containers is often costly and requires a large storage space for stocking.

The present invention provides an improvement to such conventional beverage container sleeves. These and other advantages of the invention, as well as additional inventive features, will be apparent from the description of the invention provided herein.

### BRIEF SUMMARY OF THE INVENTION

The beverage container sleeve of the present invention is a flat die-cut piece configured to be self formed on a beverage container without additional assembly by users and is adjustable to various size beverage containers.

In one aspect, the invention provides a self-forming beverage container sleeve comprising an upper flap, a lower flap and a slit line having a first end and a second end. The slit line divides the upper flap and the lower flap, and includes a first side slit line extending from the first end and a second side slit line extending from the second end. The self-forming sleeve further includes a first side flap and a second side flap connecting the upper flap and the lower flap.

In another aspect, the invention provides a method of making a beverage container sleeve comprising steps of cutting a slit line having a first end and a second end, cutting a first side slit line extending from the first end, cutting a second side slit line extending from the second end, and cutting an outline of the beverage container sleeve defining an upper flap, a lower flap, a first side flap and a second side flap.

Yet in another aspect, the invention provides a promotional item comprising an upper flap, a lower flap and a slit line having a first end and a second end. The slit line divides the upper flap and the lower flap, and includes a first side slit line extending from the first end and a second side slit line extending from the second end. The promotional item further includes a first side flap and a second side flap connecting the upper flap and the lower flap, wherein at least one of the upper flap, the lower flap, the first side flap and the second side flap is printed with promotional images or messages.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a beverage container sleeve according to a preferred embodiment of the invention;

FIG. 2 is a perspective top view of the beverage container of FIG. 1, self formed on a beverage container; and

FIG. 3 is a perspective top view of the beverage container of FIG. 2, shown without the beverage container.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

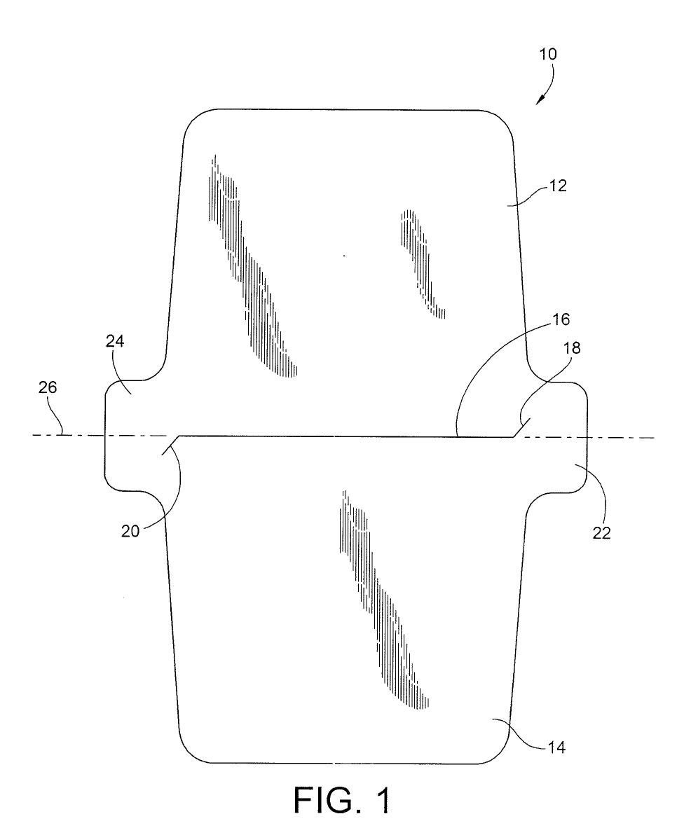

FIGS. 1-3 illustrate a preferred embodiment of a self forming beverage container sleeve (sleeve) 10 according to the present invention. FIG. 1 shows the sleeve 10 before it is self formed on a beverage container. As shown, the sleeve 10 is generally rectangular in its shape with two side tabs. The sleeve 10 is a flat die-cut piece which may be formed of a suitable material such as a corrugated paper stock readily available in the corrugated box making industry. Other suitable materials for the sleeve 10 may include, but not limited to, plastic materials such as polyester, polyethylene, or polypropylene sheet stocks and other paper stocks.

As shown in FIG. 1, the sleeve 10 comprises an upper flap 12 and a lower flap 14 divided by a slit line 16 extending across about the middle portion of the sleeve 10. Each end of the slit line 16 is extended by a side slit line 18, 20 which forms an obtuse angle with the slit line 16. The side slit lines 18, 20 extend from the slit line 16 in opposite directions. That is, one of the side slit line 18 extends toward the upper flap 12 and the other side flap 20 extends toward the lower flap 14. The sleeve 10 further includes side flaps 22, 24.

In this embodiment, as shown in FIG. 1, the upper flap 12 and the lower flap 14 are configured to have same dimensions with the slit line 16 located approximately in the center of the sleeve 10. The side flaps 22, 24, are defined by the side tabs formed about an axis 26 extending from the slit line 16. The side flaps 22, 24, which are also evenly dimensioned, are centered about the axis 26, connecting the upper flap 12 and the lower flap 14, such that upper halves of the side flaps 22, 24 are above the axis 26 with the upper flap 12 and lower halves of the side flaps 22, 24 are below the axis 26 with the lower flap 14. Thus, when the sleeve 10 is folded along the slit line 16, sides and corners of the flaps above the axis 26 are even with the respective sides and corners of the flaps below the axis 26. In other embodiments, the sleeve 10 may be designed such that the upper flap 12 and the lower flap 14 are different in their dimensions or have different shapes according to marketing needs.

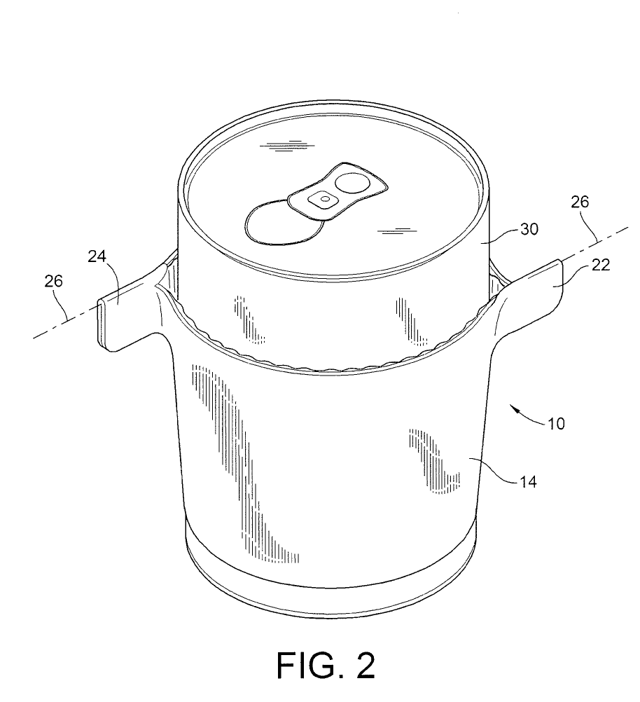

FIG. 2 illustrates the sleeve 10 after being self formed on a beverage container 30. The sleeve 10 designed according to the present invention allows the flat die-cut sleeve 10 of FIG. 1 to be easily self-formed on the beverage container 30, as shown in FIG. 2. During the self formation process, a user may hold or place the sleeve 10 on the top of the beverage container 30, and simply insert the beverage container 30 through the slit line 16. As the slit line 16 opens to receive the beverage container 30, the upper flap 12 and the lower flap 14 fold down along the periphery of the beverage container 30 and cover the surface of the beverage container 30.

As the upper and lower flaps fold down to cover the surface of the beverage container 30, the side flaps 22, 24 are also folded in half along the axis 26. As the side flaps 22, 24 are folded, the side slit lines 18, 20 direct the folded side flaps 22, 24 to bend in opposite directions. In other words, the side flap 22 is guided by the side slit line 18, which extends from the slit line 16 toward the upper flap 12 (FIG. 1), to bend toward the side of the beverage container covered by the upper flap 12, while the side flap 24 is guided by the side slit line 20, which extends from the slit line 16 toward the lower flap 14 (FIG. 1), to bend toward the side of the beverage container covered by the lower flap 14. As shown in FIG. 2, the self-formed sleeve 10 surrounds the surface of the beverage container 30 such that the lower flap 14 covers the front side of the beverage container 30 and the upper flap 16 covers the back side of the beverage container 30 with the side flaps 22, 24 forming angled, wing-like protrusions bended in opposite directions.

The sleeve 10 can accommodate beverage containers having various diameters. In a preferred embodiment, the slit line 16 is cut according to a minimum diameter of beverage containers which the sleeve 10 will accommodate. A width of the side slit lines 18, 20 may be selected relative to a desired range of beverage container diameters which the sleeve 10 can accommodate without tearing. The width of the side slit lines 18, 20 may be 10% to 40% of the width of the slit line 16, preferably 20-25%. A size of the side flaps 22, 24 may determine the largest beverage container diameter that the sleeve 10 can accommodate.

For example, one embodiment of the sleeve 10 may include the slit line 16 extending about 3⅛ inches with about ⅜ inches side slit lines 18, 20, and about ¾ inches by 1⅝ inches side flaps 22, 24. The sleeve with such configurations is well suited for beverage containers having about 2¾ inches diameter such as conventional soft drink cans and beer cans. However, such sleeve 10 may also be used with beverage containers of a smaller diameter or beverage containers of a larger diameter. When the sleeve 10 is used with a smaller diameter beverage container, the side slit lines 18, 20 may not open fully and the sleeve 10 will not tear as it is self formed on the beverage container. When the sleeve 10 is used with a larger diameter beverage container, the side flaps 22, 24 may tear and split from the end of the side slits 18, 20 as the sleeve 10 is self formed onto the beverage container. In some embodiments, the side slit lines 18, 20 may be further extended with perforated lines to promote cleaner tearing of the side flaps 22, 24 when used with a larger diameter beverage container.

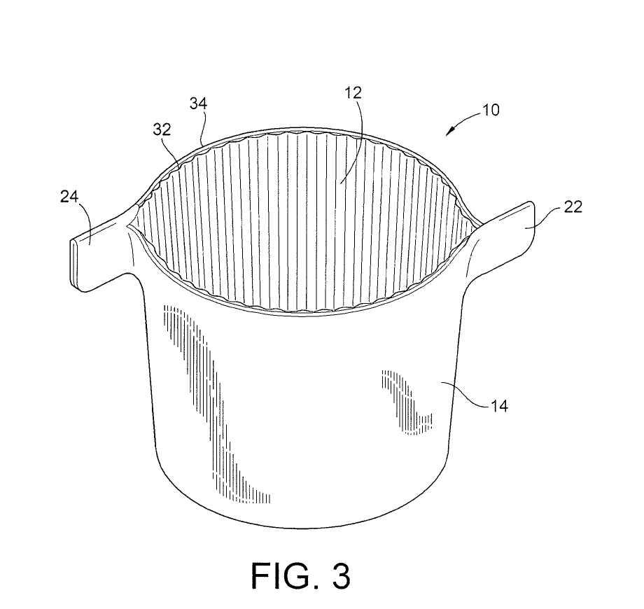

FIG. 3 illustrates the self formed sleeve 10 without the beverage container 30. As shown, the sleeve 10 is formed of a corrugated sheet including flutes 32 bonded to a liner 34. The corrugated sheet is advantageous for insulation function of the sleeve 10 as the flutes 32 permit the air to flow through the flutes as it is heated or cooled by the contents of the beverage containers. In other embodiments, the sleeve 10 may be formed from plastic sheets or other paper stocks. The sleeve 10 may also be used as a promotional or advertising medium. In such applications, a suitable material such as a corrugated sheet or other printable plastic or paper stocks having an appropriate thickness and characteristics for sleeve 10 is first printed with promotional images and/or messages. When a corrugated sheet having a liner on one side is used, the printing is performed on the liner side of the corrugated sheet. The printed material is then cut to a desired shape of the sleeve 10 in a die cutting machine. Although the embodiment shown in FIGS. 1-3 has rectangular upper and lower flaps, other embodiments may include different shapes of upper and lower flaps such as circular, star shaped, etc.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A self-forming beverage container sleeve, comprising:
an upper flap;
a lower flap;
a slit line having a first end and a second end, wherein the slit line divides the upper flap and the lower flap;
a first side slit line extending from the first end;
a second side slit line extending from the second end; and
a first side flap and a second side flap connecting the upper flap and the lower flap.

2. The self-forming beverage container sleeve of claim 1, wherein the first side slit line forms an obtuse angle with the slit line and the second side slit line forms an obtuse angle with the slit line.

3. The self-forming beverage container of claim 2, wherein the first side slit line extends from the slit line toward the upper flap, and the second side slit line extends from the slit line toward the lower flap.

4. The self-forming beverage container of claim 1, wherein the slit line is adapted to receive a beverage container.

5. The self-forming beverage container of claim 4, wherein the upper flap and the lower flap are configured to fold down, covering the surface of the beverage container as the beverage container is received through the slit line.

6. The self-forming beverage container sleeve of claim 4, wherein the first and second side slit lines are configured to direct the side flaps to bend in opposite directions as the beverage container is received through the slit line.

7. The self-forming beverage container sleeve of claim 1, wherein the upper flap and the lower flap are printed with promotional images and messages.

8. The self-forming beverage container sleeve of claim 1, wherein the self-forming beverage container sleeve is formed of a corrugated material.

9. The self-forming beverage container sleeve of claim 1, wherein the self-forming beverage container sleeve is formed of a sheet of plastic material.

10. A method of making a beverage container sleeve comprising steps of:
cutting a slit line having a first end and a second end;
cutting a first side slit line extending from the first end;
cutting a second side slit line extending from the second end; and
cutting an outline of the beverage container sleeve defining an upper flap, a lower flap, a first side flap and a second side flap.

11. The method of making the beverage container sleeve of claim 10 further comprising a printing of promotional images and messages on the beverage container sleeve.

12. The method of making the beverage container sleeve of claim 10, wherein the step of cutting a first side slit line includes cutting the first side slit line extending from the first end and forming an obtuse angle with the slit line, and the step of cutting a second side slit line includes cutting the second side slit line extending from the second end and forming an obtuse angle with the slit line.

13. The method of making the beverage container sleeve of claim 12, wherein the step of cutting a first side slit line and the step of cutting a second slit line include cutting the first side slit line and cutting the second side slit line such that the first slide slit line and the second side slit line are shorter than the slit line.

14. The method of making the beverage container sleeve of claim 10, wherein the cutting a slit line, the cutting a first side slit line, the cutting a second side slit line and the cutting an outline are performed in a die cutting machine.

15. The method of making the beverage container sleeve of claim 14 further including slitting a beverage container sleeve material according to a width of the die cutting machine.

16. The method of making the beverage container sleeve of claim 1, wherein the beverage container sleeve is made of a corrugated material.

17. The method of making the beverage container sleeve of claim 1, wherein the beverage container sleeve is made of a printable plastic stock.

18. A promotional item, comprising:
an upper flap;
a lower flap;
a slit line having a first end and a second end, wherein the slit line divides the upper flap and the lower flap;
a first side slit line extending from the first end;
a second side slit line extending from the second end; and
a first side flap and a second side flap connecting the upper flap and the lower flap;
wherein at least one of the upper flap, the lower flap, the first side flap and the second side flap is printed with promotional images or messages.

19. The promotional item of claim 18, wherein the slit line is configured to receive a beverage container.

20. The promotional item of claim 19, wherein the promotional item self forms on the beverage container, wherein the upper flap and the lower flap fold down covering the beverage container, the first side flap and the second side flap are folded in half and bend in opposite directions guided by the first side slit line and the second side slit line.
